(19) United States
(12) Patent Application Publication
(10) Pub. No.: US 2025/0034433 A1
(43) Pub. Date: Jan. 30, 2025

(54) PRESSURE-SENSITIVE ADHESIVE TAPE AND USE THEREOF

(71) Applicant: NITTO DENKO CORPORATION, Ibaraki-shi, Osaka (JP)

(72) Inventors: Kosuke MORITA, Ibaraki-shi, Osaka (JP); Yoshio NAKAGAWA, Ibaraki-shi, Osaka (JP); Tomohito HARADA, Ibaraki-shi, Osaka (JP)

(73) Assignee: NITTO DENKO CORPORATION, Ibaraki-shi, Osaka (JP)

(21) Appl. No.: 18/710,884

(22) PCT Filed: Nov. 17, 2022
(86) PCT No.: PCT/JP2022/042659

§ 371 Date: May 16, 2024

(30) Foreign Application Priority Data
Nov. 19, 2021 (JP) 2021-188698

(51) Int. Cl. C09J 7/24

(52) U.S. Cl. CPC C09J 7/245; C09J 2203/302; C09J 2301/312; C09J 2475/006

(57) ABSTRACT

Provided is a PSA tape comprising a substrate layer formed of a polyvinyl chloride film, and a PSA layer on at least one side of the substrate layer. The substrate layer comprises polyvinyl chloride, a plasticizer, and an elastomer. The elastomer comprises at least a thermoplastic polyurethane or a thermoplastic polyester elastomer.

### TECHNICAL FIELD

The present invention relates to a pressure-sensitive adhesive (PSA) tape including polyvinyl chloride film (PVC film), and a wire harness using the PSA tape.

The application claims priority to Japanese Patent Application No. 2021-188698 filed on Nov. 19, 2021; and the entire content thereof is incorporated herein by reference.

### BACKGROUND ART

Due to its good workability, PSA tape having a PSA layer at least on one side of PVC film (or “PVC adhesive tape” hereinafter) has been widely used for various purposes such as electrical insulation, wrapping, and protection. Conventional technical documents related to PVC adhesive tapes include Patent Documents 1 to 3.

### CITATION LIST

### Patent Literature

[Patent Document 1] WO2019/069577

[Patent Document 2] WO2018/225541

[Patent Document 3] WO2019/049565

### SUMMARY OF INVENTION

### Technical Problem

The PVC adhesive tape has been preferably used as wire-binding tape in a wire harness formed of a group of numerous electric wires (or simply “wires”) routed in automobiles, aircraft, and the like (or “vehicles” hereinafter). At room temperature (in the room temperature range), which is generally the environmental temperature for wire wrapping, PVC adhesive tapes for the above purposes need to exhibit good flexibility suited for the wrapping work. For installation space limitations, harnesses may be bent sharply in the installation process and may be subjected to bending deformation after installation as well, due to vibrations and shocks associated with vehicle operation. Depending on the routing path, wire harnesses may also interfere with the bodies and other parts. Wire harnesses used in vehicles can be exposed to a wide range of temperatures. While they may be exposed to temperatures at or below −30° C. in some cases, they can also be subjected to heat from the power source, sunlight, etc. Thus, it is desirable that the PVC adhesive tape is easily deformable and less susceptible to cracking and clouding (turning white) even when the wire harness is bent and deformed at low temperatures while being less susceptible to deformation and denting due to load or stress (i.e., having good deformation resistance) at high temperatures. This is because the cracking and clouding at low temperatures and the deformation and denting at high temperatures can weaken the protection provided by the PVC adhesive tape.

However, it is not easy to achieve a good balance between PVC adhesive tape's easy deformability at low temperatures, good flexibility at room temperature, and deformation resistance at high temperatures. For instance, increasing the plasticizer amount of PVC film generally increases flexibility at room temperature, but tends to impair deformation resistance at high temperatures.

Accordingly, an objective of this invention is to provide a PSA tape that has a PSA layer on at least one face of a substrate layer formed of a PVC film while having a good balance between easy deformability at low temperatures, flexibility at room temperature, and deformation resistance at high temperatures. Another related objective is to provide a wire harness using such a PSA tape.

### Solution to Problem

The description provides a PSA tape having a substrate layer formed from a polyvinyl chloride-based film, and a PSA layer disposed on at least one face of the substrate layer. In the PSA tape, the substrate layer comprises polyvinyl chloride (PVC), a plasticizer, and an elastomer. The elastomer comprises at least a thermoplastic polyurethane (TPU) or a thermoplastic polyester elastomer (TPEE). A PSA tape in this embodiment can combine easy deformability at low temperatures, flexibility at room temperature, and deformation resistance at high temperatures in a well-balanced manner. For instance, such a PSA tape is favorably used for protecting and binding wires in a wire harness.

In some preferable embodiments, the substrate layer comprises the elastomer in an amount of 3.0 wt % or greater and 30 wt % or less. The PSA tape having a substrate layer satisfying the elastomer amount can preferably bring about the effect of the art disclosed herein.

The substrate layer in the PSA tape disclosed herein preferably comprises at least a TPU as the elastomer. The PSA tape having a TPU-containing PVC film as the substrate layer can preferably bring about the effect of the art disclosed herein.

In some embodiments where the substrate layer comprises a TPU, the TPU may have a urethane bond fraction of, for instance, 10 mol % or higher and 20 mol % or lower (mol %=% by mole). The art disclosed herein can be preferably implemented, using a TPU having a urethane bond fraction within this range.

In some embodiments, the elastomer favorably satisfies at least a durometer hardness of A75 or greater and A95 or less, or a durometer hardness of D25 or greater and D45 or less. The substrate layer comprising an elastomer that satisfies the durometer hardness helps obtain a PSA tape with well-balanced properties at low temperatures, room temperature, and high temperatures.

In some preferable embodiments, the substrate layer comprises the plasticizer in an amount of 15 wt % or greater and 30 wt % or less. In the PSA tape having a substrate that satisfies the plasticizer amount, the effect of the art disclosed herein can be preferably obtained.

In some embodiments, the substrate layer preferably has a ratio of the elastomer amount to the plasticizer amount of 0.1 or higher and 1.5 or lower on weight basis. The combined use of the elastomer and the plasticizer at such an amount ratio can preferably bring about the effect of the art disclosed herein.

This description also provides a wire harness with a PSA tape disclosed herein wrapped around the wires. A wire harness in this embodiment is less susceptible to cracking and clouding of the substrate layer even when bent and deformed at low temperatures. It is also less susceptible to deformation and denting of the substrate layer even under load or stress at high temperatures. Therefore, it can provide good protection to the wires.

### BRIEF DESCRIPTION OF DRAWINGS

FIG. 1 shows a schematic cross-sectional view illustrating a configuration of the PSA tape according to an embodiment.

FIG. 2 shows a schematic diagram illustrating a low-temperature bend test.

FIG. 3 shows a schematic diagram illustrating bending rigidity measurement at room temperature.

FIG. 4 shows a schematic diagram illustrating thermal deformation measurement.

### DESCRIPTION OF EMBODIMENTS

Preferred embodiments of the present invention are described below. Matters necessary to practice this invention other than those specifically referred to in this description can be understood by a person skilled in the art based on the disclosure about implementing the invention in this description and common technical knowledge at the time the application was filed. The present invention can be practiced based on the contents disclosed in this description and common technical knowledge in the subject field.

### <Configuration Example of PSA Tape>

The PSA tape disclosed herein includes a substrate layer formed of a polyvinyl chloride-based film, and a PSA layer disposed on at least one side of the substrate layer. The PSA tape may be, for instance, a single-sided PSA tape with a substrate (support substrate) having a PSA layer on one side of the substrate, or may be a double-sided PSA tape with a substrate having a PSA layer on each side of the substrate. The PSA tape disclosed herein may be in a roll or in sheets. The PSA tape may also be processed to have slits on a tape edge to facilitate its cutting in tape wrapping.

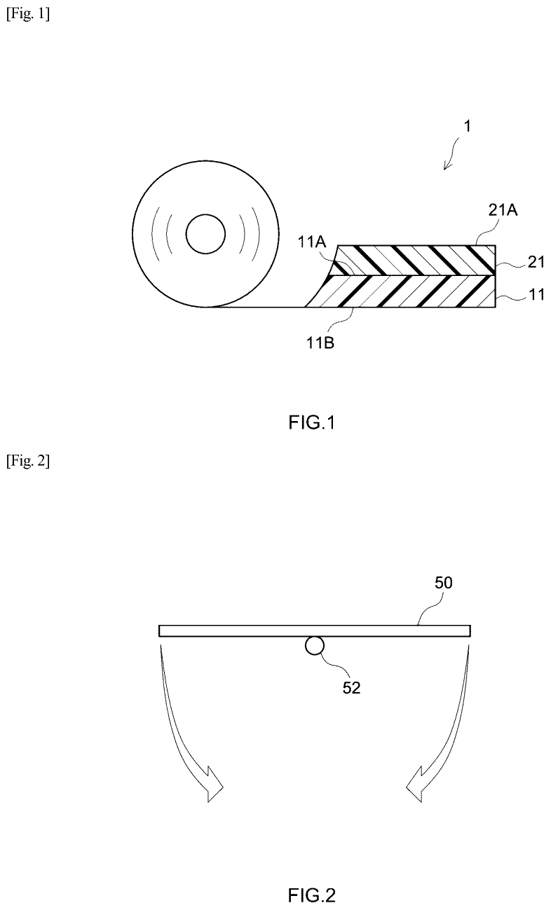

FIG. 1 shows a configuration example of the PSA tape disclosed herein. PVC adhesive tape 1 shown in FIG. 1 is constituted as a single-faced PSA tape that comprises a substrate layer (e.g., monolayer PVC film) 11 having a first face 11A and a second face 11B, and a PSA layer 21 placed on the first face HA. In a preferable embodiment, for instance, as shown in FIG. 1, PSA tape 1 before use (i.e., before adhering to adherend) may be in a PSA tape roll form wound in the length direction with the second face 11B of the support substrate in contact with the PSA layer 21 to protect its surface (adhesive face) 21A. Alternatively, it may be in a form where the surface 21A of the PSA layer 21 is protected with a release liner having a release face at least on the side that faces the PSA layer 21. As the release liner, a known or commonly-used liner can be used without particular limitations. Examples include a release liner having a release layer on a surface of a substrate such as plastic film and paper and a release liner formed from a low adhesive material such as fluorine-based polymers (polytetrafluoroethylene, etc.) and polyolefin-based resins (polyethylene, polypropylene, etc.).

### <Substrate Layer>

The substrate layer disclosed herein is formed of a PVC film. The PVC film can be obtained by forming a sheet (film) from a PVC composition including prescribed ingredients by a known method. The PVC composition here refers to a composition whose primary component (i.e., a component accounting for more than 50 wt %) among resins is PVC. Such a PVC composition can form a PVC film (typically a film formed of a soft PVC resin) that exhibits favorable physical properties as a PSA tape substrate. The amount of PVC in the resin content of the PVC composition is preferably 55 wt % or greater, more preferably about 65 wt % or greater, possibly 75 wt % or greater, 80 wt % or greater, 85 wt % or greater, or even 90 wt % or greater. The amount of PVC in the resin content of the PVC composition can be, for instance, 99 wt % or less. In view of readily obtaining the effect of including the elastomer, in some embodiments, the amount of PVC is suitably 98 wt % or less, preferably 96 wt % or less, more preferably 94 wt % or less, possibly 90 wt % or less, 85 wt % or less, or even 80 wt % or less.

### (PVC)

The PVC forming the PVC composition can be various species of polymer whose primary monomer (the primary component among monomers, i.e., a monomer accounting for more than 50 wt %) is vinyl chloride. In other words, the concept of PVC here encompasses copolymers of vinyl chloride and various comonomers as well as vinyl chloride homopolymer. Examples of the comonomers include vinylidene chloride; olefins such as ethylene and propylene (preferably olefins with 2 to 4 carbons); carboxy group-containing monomers such as acrylic acid, methacrylic acid (hereinafter, (meth)acryl is used to comprehensively refer to acryl and methacryl), maleic acid and fumaric acid as well as their acid anhydrides (maleic acid anhydride, etc.); (meth)acrylic acid esters, e.g., esters of (meth)acrylic acid and alkyl alcohols or cycloalkyl alcohols with about 1 to 10 carbons; vinyl ester-based monomers such as vinyl acetate and vinyl propionate; styrene-based monomers such as styrene, substituted styrenes (α-methylstyrene, etc.) and vinyl toluene; and acrylonitrile. As the copolymer, a copolymer in which the copolymerization ratio of vinyl chloride is 70 wt % or greater (more preferably 90 wt % or greater) is preferable. The PVC can be obtained by polymerizing these monomers by a suitable method (typically a suspension polymerization method).

The average degree of polymerization of the PVC in the PVC composition can be, but not particularly limited to, for instance, about 800 to 1800. In view of the balance between the workability (ease of molding) and the strength, etc., a preferable PVC composition has an average degree of polymerization of about 1000 to 1500.

The PVC content (amount) of the substrate layer is typically 30 wt % or more, or possibly 35 wt % or more. In view of favorably obtaining the effect of PVC, the PVC content is suitably 40 wt % or more (e.g., more than 40 w (%), preferably 45 wt % or more, more preferably 48 wt % or more, possibly 50 wt % or more (e.g., above 50 wt %), 52 wt % or more, 55 wt % or more, or even 57 wt % or more. The maximum PVC content of the substrate layer is, for instance, approximately 80 wt % or less. In view of allowing the plasticizer and elastomer in the substrate layer to work more effectively, it is preferably 75 wt % or less, more preferably 70 wt % or less, or possibly, for instance, 65 wt % or less.

### (Plasticizer)

The substrate layer disclosed herein includes a plasticizer. The combined use of plasticizer and elastomer can preferably bring about a PSA tape that has a good balance of easy deformability at low temperatures, good flexibility at room temperature, and deformation resistance at high temperatures. As the plasticizer, various materials known to plasticize PVC (e.g., at least at room temperature (typically at 23° C.)) can be used without particular limitations. Examples of the plasticizer include, but not limited to, aromatic carboxylic acid esters such as benzoic acid esters (glycol benzoic acid esters), phthalic acid esters, terephthalic acid esters (di-2-ethylhexyl phthalate, etc.), trimellitic acid esters and pyromellitic acid esters; aliphatic carboxylic acid esters such as adipic acid esters, sebacic acid esters, azelaic acid esters, maleic acid esters and citric acid esters (tributyl acetylcitrate, etc.); polyesters of polycarboxylic acids and polyols; as well as polyether-based polyesters; epoxy-based polyesters (epoxidized vegetable oils such as epoxidized soybean oil and epoxidized linseed oil, epoxidized aliphatic acid alkyl esters, etc.); and phosphoric acid esters (tricresyl phosphate, etc.). For the plasticizer, solely one species or a suitable combination of two or more species can be used.

As the phthalic acid ester (phthalate-based plasticizer), for instance, a diester of phthalic acid and an alkyl alcohol with 4 to 16 (preferably 6 to 14, typically 8 to 13) carbons can be used. Favorable examples include di-n-octyl phthalate, di-2-ethylhexyl phthalate, diisononyl phthalate and diisodecyl phthalate.

As the trimellitic acid ester (trimellitate-based plasticizer), e.g., a triester of trimellitic acid and an alkyl alcohol with 6 to 14 (typically 8 to 12) carbons can be used. Favorable examples include tri-n-octyl trimellitate, tri-2-ethylhexyl trimellitate, triisononyl trimellitate, tri-n-decyl trimellitate and triisodecyl trimellitate.

As the pyromellitic acid ester (pyromellitate-based plasticizer), for instance, a tetraester of pyromellitic acid and an alkyl alcohol with 6 to 14 (typically 8 to 12) carbons can be used. Favorable examples include tetra-n-octyl pyromellitate, tetra-2-ethylhexyl pyromellitate and tri-n-decyl pyromellitate.

As the adipic acid ester (adipate-based plasticizer), for instance, a diester of adipic acid and an alkyl alcohol with 4 to 16 (preferably 6 to 14, typically 8 to 13) carbons can be used. Favorable examples include di-n-octyl adipate, di-2-ethylhexyl adipate and diisononyl adipate.

As the polyester (polyester-based plasticizer), for instance, a polyester can be used, which is obtainable from a polycarboxylic acid (e.g., succinic acid, adipic acid, suberic acid, azelaic acid, sebacic acid, citric acid, phthalic acid, isophthalic acid, terephthalic acid, trimellitic acid, etc.) and a polyol (e.g., (poly)ethylene glycol (the term “(poly)ethylene glycol” here comprehensively referring to ethylene glycol and polyethylene glycol, the same applies hereinafter), (poly) propylene glycol, (poly)butylene glycol, (poly) hexanediol, (poly) neopentyl glycol, polyvinyl alcohol, etc.). As the polycarboxylic acid, an aliphatic dicarboxylic acid with 4 to 12 (typically 6 to 10) carbons is preferable, with favorable examples including adipic acid and sebacic acid. In particular, in view of the availability and cost, adipic acid is desirable. As the polyol, an aliphatic diol with 2 to 10 carbons is preferable, with favorable examples including ethylene glycol and butylene glycol (e.g., 1,3-butanediol, 1,4-butanediol).

In some preferable embodiments, a carboxylic acid ester (carboxylate) is preferably used as the plasticizer in the substrate layer. As the carboxylate, solely one species or a combination of two or more species can be used among the aforementioned aromatic and aliphatic carboxylates.

The molecular weight of the plasticizer is not particularly limited. Some embodiments use a plasticizer having a molecular weight below 1500 (e.g., below 1000). The plasticizer may can have a molecular weight of, for instance, 250 or higher, or 400 or higher. The maximum molecular weight of the plasticizer is not particularly limited. In view of handling properties, etc., it is preferable to use a plasticizer having a molecular weight of 800 or lower (e.g., below 600, or even below 500). In particular, a carboxylate having such a molecular weight is preferably used.

In some embodiments, the substrate layer may comprise a polyester-based plasticizer as the plasticizer. Such an embodiment helps obtain a PSA tape that combines heat degradation resistance and other properties at a high level. In some preferable embodiments, the substrate layer comprises a polyester-based plasticizer and a carboxylate in combination. According to the embodiments, the intermolecular interaction between the polyester-based plasticizer and the carboxylate can reduce the carboxylate volatilization and migration to the PSA layer. This is preferable in view of reducing heat degradation of the substrate layer and changes in adhesive strength with time.

In an embodiment where the substrate layer comprises a polyester-based plasticizer and a carboxylate in combination, it is preferable to use a polyester-based plasticizer having a molecular weight of 1000 or higher and a carboxylate having a molecular weight below 1000 together.

As the carboxylate having a molecular weight below 1000 (PLL), solely one species or a combination of two or more species can be used among species having a molecular weight below 1000 among aromatic and aliphatic carboxylates as those described above. Examples include phthalates (di-n-octyl phthalate, di-2-ethylhexyl phthalate, diisononyl phthalate, diisodecyl phthalate, etc.), adipates (di-n-octyl adipate, di-2-ethylhexyl adipate, diisononyl adipate, etc.), trimellitates (tri-n-octyl trimellitate, tri-2-ethylhexyl trimellitate, etc.), pyromellitates (tetra-n-octyl pyromellitate, tetra-2-ethylhexyl pyromellitate, tri-n-decyl pyromellitate, etc.), citrates, sebacates, azelates, maleates and benzoates.

As the PLL, an aromatic carboxylate can be preferably used. In particular, an ester compound derived from a tri-functional or higher (typically tri-functional or tetra-functional) aromatic carboxylic acid is preferable, with specific examples including trimellitates and pyromellitates. Such a PLL readily exhibits the effect of the intermolecular interaction and is also compatible with PVC. It is also preferable as it tends to be less volatile as compared to an ester derived from a monofunctional or difunctional aromatic carboxylic acid.

The PLL typically has a molecular weight of 250 or higher. In view of heat degradation resistance, etc., it is preferably 400 or higher, or more preferably 500 or higher. The art disclosed herein can be preferably implemented in an embodiment using a PLL having a molecular weight of 600 or higher (more preferably 650 or higher, e.g., 700 or higher). The maximum molecular weight of the PLL is not particularly limited as long as it is below 1000. Usually, from the standpoint of the handling properties, etc., a PLL having a molecular weight of 950 or lower (e.g., 900 or lower) can be preferably used.

The number of carbons in the ester residue in the PLL is preferably 6 or greater, or more preferably 8 or greater. Such a PLL is likely to exhibit the effect of the intermolecular interaction. It is also preferable as the volatility tends to decrease with increasing molecular weight. In addition, long molecular chains increase flexibility to make it easier to have a liquid form at room temperature, facilitating handling. The maximum number of carbons in the ester residue is not particularly limited. From the standpoint of the handling properties, compatibility to PVC, etc., it is usually 16 or less, preferably 14 or less, or more preferably 12 or less (e.g., 10 or less).

As the polyester-based plasticizer having a molecular weight of 1000 or higher (PLH), solely one species or a combination of two or more species can be used from species having a molecular weight of 1000 or higher among polyester-based plasticizers as those described above. In view of plasticization and flexibility at low temperatures, a polyester of an aliphatic dicarboxylic acid having 4 to 12 (typically 6 to 10) carbons and a polyol is preferable. Among them, an adipic acid-based polyester plasticizer obtained from a dicarboxylic acid whose primary component is adipic acid and an aliphatic diol such as neopentyl glycol, propylene glycol or ethylene glycol. Such an adipic acid-based polyester plasticizer has a great degree of intermolecular interaction with PLL and PVC, thereby preferably inhibiting volatilization of plasticizer.

Specific examples of commercial products that can be used as the PLH in the art disclosed herein include product names W-230H, W-1020EL, W-1410EL, W-2050, W-2300, W-2310, W-2314, W-2360, W-360ELS and W-4010 available from DIC Corporation; product names P-300, PN-250, PN-400, PN-650, PN-1030 and PN-1430 available from ADEKA Corporation; and product name HA-5 available from Kao Corporation.

The PLH preferably has a molecular weight of 1000 or higher. In view of readily obtaining desirable effects, it is advantageous to use a PLH having a molecular weight of 2000 or higher (preferably 2500 or higher, e.g., 3000 or higher). The art disclosed herein can be preferably implemented in an embodiment using a PLH having a molecular weight of 4000 or higher (e.g., 5000 or higher). The maximum molecular weight of the PLH is not particularly limited, but it is usually suitably less than 100000. From the standpoint of obtaining the plasticizing effect of PVC to a greater extent to readily bring about the flexibility required of the PVC adhesive tape, the molecular weight of the PLH is preferably below 50000, more preferably below 25000, or yet more preferably below 10000

The “molecular weight” of a plasticizer herein is determined from its chemical formula. A molecular weight of 1000 or higher is obtained based on standard polystyrene by gel permeation chromatography (GPC).

In an embodiment using PLH and PLL as the plasticizer in the substrate layer, the relative amount of PLH to PLL is not particularly limited. For instance, the PLH weight (W_{PLH}) to PLL weight (W_{PLL}) ratio (i.e., W_{PLH}/W_{PLL}) in the substrate layer can be about 0.1 to 500. In view of suitably obtaining the combined use effect, W_{PLH}/W_{PLL} is advantageously 0.5 to 100, or preferably 1 to 50. In some preferable embodiments, W_{PLH}/W_{PLH}, is possibly 1 to 25, more preferably 1 to 15 (e.g., 1 to 10), or yet more preferably above 1 and below 7 (typically above 1 and below 5, e.g., 2 to 4.5).

In the art disclosed herein, the amount of plasticizer (the total amount when using two or more species) in the substrate layer is not particularly limited and can be suitably set to obtain desirable effects. In some embodiments, the plasticizer content of the substrate layer can be selected, for instance, within the range between 10 wt % and 40 wt %. In view of flexibility from low temperatures to room temperature, the plasticizer content of the substrate layer is advantageously 15 wt % or greater, preferably 18 wt %, or greater, possibly 20 wt % or greater, or 22 wt % or greater. The plasticizer content of the substrate layer is advantageously below 36 wt %, preferably 30 wt % or less (e.g., below 30 wt %), possibly 28 wt % or less, 25 wt % or less, 23 wt % or less. The plasticizer content can be preferably applied to the substrate layer in the PSA tape used for protecting or binding electric wires of a wire harness.

The plasticizer content may also be specified relative to PVC in the substrate layer. The amount of plasticizer (the total amount when using two or more species) per 100 parts by weight of PVC can be selected, for instance, within the range between 25 parts and 70 parts by weight. In some embodiments, in view of flexibility from low temperatures to room temperature, the plasticizer content per 100 parts of PVC (by weight) is suitably 30 parts or greater, preferably 35 parts or greater, possibly 37 parts or greater, or 39 parts or greater. In view of deformation resistance at high temperatures, the plasticizer content per 100 parts of PVC (by weight) is suitably 55 parts or less, advantageously 50 parts or less (e.g., below 50 parts), possibly 48 parts or less, 46 parts or less, or 45 parts or less.

### (Elastomer)

The substrate layer in the art disclosed herein further comprises an elastomer. As the elastomer, a thermoplastic elastomer is preferably used. In particular, the elastomer preferably includes at least a thermoplastic polyurethane (TPU) or thermoplastic polyester elastomer (TPEE). This can maintain or improve high-temperature properties (e.g., low thermal deformation measured by the method described later in Examples) while improving low-temperature properties (e.g., reduced cracking in bending deformation of wire harness) and increasing flexibility at room temperature.

Thermoplastic polyurethane (TPU) is a multiblock copolymer formed of hard and soft segments. Examples of TPU include polyester-based, polyether-based and polycarbonate-based thermoplastic polyurethanes. In particular, polyester-based and polyether-based thermoplastic polyurethanes are preferable. For the thermoplastic polyurethane, solely one species or a combination of two or more species can be used.

A thermoplastic polyurethane is generally prepared using a polyol and a diisocyanate, optionally with a chain extender as well. Examples of the polyol include a polyester polyol, polyester-ether polyol, polycarbonate polyol, and polyether polyol.

The polyester polyol can be obtained by dehydration condensation reaction of a dicarboxylic acid, ester or anhydride thereof and a polyol. The dicarboxylic acid can be an aliphatic dicarboxylic acid (e.g., succinic acid, adipic acid, sebacic acid, azelaic acid), aromatic dicarboxylic acid (e.g., phthalic acid, terephthalic acid, isophthalic acid, naphthalene dicarboxylic acid), or alicyclic dicarboxylic acid (e.g., hexahydrophthalic acid, hexahydroterephthalic acid, hexahydroisophthalic acid). The polyol can be ethylene glycol, 1,3-propylene glycol, 1,2-propylene glycol, 1,3-butanediol, 1,4-butanediol, and 1,5-pentanediol, 1,6-hexanediol, 3-methyl-1,5-pentanediol, neopentyl glycol, 1,3-octanediol, 1,9-nonanediol, or a mixture thereof. Other examples of the polyester polyol include a polylactone diol obtainable by ring-opening polymerization of a lactone monomer such as ε-caprolactone.

The polyester-ether polyol can be obtained by dehydration condensation reaction of a dicarboxylic acid, ester or anhydride thereof and a polyol. The dicarboxylic acid can be an aliphatic dicarboxylic acid (e.g., succinic acid, adipic acid, sebacic acid, azelaic acid), aromatic dicarboxylic acid (e.g., phthalic acid, terephthalic acid, isophthalic acid, naphthalene dicarboxylic acid), or alicyclic dicarboxylic acid (e.g., hexahydrophthalic acid, hexahydroterephthalic acid, hexahydroisophthalic acid). The polyol can be a glycol such as diethylene glycol and a propylene oxide adduct, or a mixture thereof.

The polycarbonate polyol can be obtained by reaction of one, two or more species of polyol and a carbonate. Examples of the polyol include ethylene glycol, 1,3-propylene glycol, 1,2-propylene glycol, 1,3-butanediol, 1,4-butanediol, 1,5-pentanediol, and 1,6-hexanediol, 3-methyl-1,5-pentanediol, neopentyl glycol, 1,8-octanediol, 1,9-nonanediol, and diethylene glycol. Examples of the carbonate include diethylene carbonate, dimethyl carbonate, and diethyl carbonate. Other examples of the polycarbonate polyol include a copolymer of polycaprolactone polyol (PCL) and polyhexamethylene carbonate (PHL).

Examples of the polyether polyol include polyethylene glycol, polypropylene glycol, and polytetramethylene ether glycol obtainable by polymerization of the corresponding cyclic ethers such as ethylene oxide, propylene oxide, and tetrahydrofuran; and copolyethers thereof.

Examples of the diisocyanate include tolylene diisocyanate (TDI), 4,4′-diphenylmethane diisocyanate (MDI), 1,5-naphthylene diisocyanate (NDI), tolidine diisocyanate, 1,6-hexamethylene diisocyanate (HDI), isophorone diisocyanate (IPDI), xylylene diisocyanate (XDI), hydrogenated XDI, triisocyanate, tetramethylxylene diisocyanate (TMXDI), 1,6,11-undecanetriisocyanate, 1,8-diisocyanate methyloctane, lysine ester triisocyanate, 1,3,6-hexamethylene triisocyanate, bicycloheptane triisocyanate, and dicyclohexylmethane diisocyanate (hydrogenated MDI or HMDI).

In the TPU preparation, a lower polyol is used as the chain extender. Examples of the lower polyol include aliphatic polyols such as ethylene glycol, 1,3-propylene glycol, 1,2-propylene glycol, 1,3-butanediol, 1,4-butanediol, 1,5-pentanediol, 1,6-hexanediol, 3-methyl-1,5-pentanediol, neopentyl glycol, 1,8-octanediol, 1,9-nonanediol, diethylene glycol, 1,4-cyclohexanedimethanol, and glycerin; and aromatic glycols such as 1,4-dimethylolbenzene, bisphenol A, and ethylene or propylene oxide adduct of bisphenol A.

Commercially-available polyester-based thermoplastic polyurethanes include the ELASTOLLAN C series (C90A10, C80A10, etc.), ELASTOLLAN S series, ELASTOLLAN ETS series and ELASTOLLAN ET6 series available from BASF Corporation; and the RESAMINE P-4000 series and RESAMINE P-4500 series available from Dainichiseika Color & Chemicals Mfg. Co., Ltd. Commercially-available polyether-based thermoplastic polyurethanes include the ELASTOLLAN 11 series (1180A10, etc.), ELASTOLLAN ET3 series, and ELASTOLLAN ET8 series available from BASF Corporation; and the RESAMINE P-2000 series available from Dainichiseika Color & Chemicals Mfg. Co., Ltd. Commercially-available polycarbonate-based thermoplastic polyurethanes include PANDEX T-7890N available from DIC Bayer Polymer Ltd.

In some embodiments, as the thermoplastic polyurethane, it is preferable to use a species having a urethane bond fraction in the range of 5 mol % or higher and 25 mol % or lower (more preferably 10 mol % or higher and 20 mol % or lower). In a thermoplastic polyurethane, urethane bonds correspond to bond segments. Thus, with decreasing urethan bond fraction, the thermoplastic polyurethane tends to be softer. A thermoplastic polyurethane having a urethane bond fraction in these ranges can be used to favorably bring about a PSA tape that exhibits well-balanced properties at low, room and high temperatures.

The urethan bond fraction of a thermoplastic polyurethane can be determined as follows:

The thermoplastic polyurethan to be measured is hydrolytically decomposed into individual structural units, taking advantage of the supercritical state of methanol. Subsequently, by GC-MS (gas chromatography-mass spectrometry), ¹H NMR and ¹³C NMR (solvent: DMSO-d6), the mole fraction of each structural unit is calculated. The urethane bond fraction (mol %) of the thermoplastic polyurethane is determined by the next equation:

urethane bond fraction=amount of isocyanates/amount of all monomers

Thermoplastic polyester elastomer is a multiblock copolymer formed of hard and soft segments. Favorable hard segments include aromatic polyesters. Specific examples include polybutylene terephthalate and polybutylene naphthalate. Among them, solely one species or a combination of two or more species can be used.

Favorable soft segments include aliphatic polyethers, aliphatic polyesters and polycarbonates. Specific examples include poly(ε-caprolactone), polytetramethylene glycol and polyalkylene carbonates. Among them, solely one species or a combination of two or more species can be used.

As such a block copolymer, one or more species of copolymer are preferable, selected from the group consisting of polyester-polyester copolymers, polyester-polyether copolymers, and polyester-polycarbonate copolymers.

Examples of commercially-available polyester-based thermoplastic elastomers include the HYTREL series available from Du Pont-Toray Co., Ltd. and the PELPRENE series available from Toyobo MC Corporation.

The elastomer in the substrate layer in the art disclosed herein may also include one, two or more species of other elastomers (i.e., elastomers other than TPU and TPEE). Examples of the other elastomers include chlorinated polyethylene (CPE), ethylene-vinyl acetate copolymer, (meth)acrylate-butadiene-styrene copolymer (e.g., methyl methacrylate-butadiene-styrene copolymer), acrylonitrile-butadiene-styrene copolymer, acrylonitrile-butadiene copolymer (NBR), styrene-butadiene copolymer, styrene-butadiene-styrene copolymer, chlorosulfonated polyethylene (CSM), other synthetic rubbers (isoprene rubber, butadiene rubber, etc.), their composites and modification products. In view of helping to favorably obtain the effect of TPU and/or TPEE, in some embodiments, of the entire elastomer, the amount of other elastomers is suitably less than 50 wt %, preferably 30 wt % or less, more preferably 15 wt % or less, possibly 10 wt % or less, or 5 wt % or less. These other elastomers may not be used. The art disclosed herein can be preferably implemented in an embodiment where the elastomer in the substrate layer consists of one, two or more species of thermoplastic elastomer selected from the group consisting of TPUs and TPEEs.

In some embodiment, the elastomer used in the substrate layer preferably satisfies at least a durometer hardness of A75 or greater and A95 or less, or a durometer hardness of D25 or greater and D45 or less. The substrate layer comprising an elastomer that satisfies the durometer hardness helps obtain a PSA tape that exhibits well-balanced properties at low, room and high temperatures.

Here, the durometer hardness of an elastomer is determined based on JIS K7311. If available, nominal values provided by manufacturers can be used.

The amount of elastomer in the substrate layer is not particularly limited and can be suitably set to obtain desirable effects. In some embodiments, the elastomer content of the substrate layer is suitably 1 wt % or greater, preferably 2 wt % or greater, more preferably 3 wt % or greater, possibly 4 wt % or greater, 5 wt % or greater, 7 wt % or greater, 10 wt % or greater, 15 wt % or greater, or 20 wt % or greater. A high elastomer content tends to better bring about the effect of the elastomer (e.g., effect of maintaining or reducing thermal deformation while improving low-temperature properties and decreasing bending rigidity at room temperature). In some embodiments, in view of compatibility with PVC, etc., the elastomer content of the substrate layer is suitably less than 50 wt %, for instance, possibly 40 wt % or less, 30 wt % or less, less than 20 wt %, less than 15 wt %, less than 10 wt %, or less than 8 wt %.

The elastomer content may also be specified relative to PVC in the substrate layer. The amount of elastomer (the total amount when using two or more species) per 100 parts by weight of PVC can be selected, for instance, within the range between 1 part and 100 parts by weight. In view of increasing the effect of including the elastomer, in some embodiments, the elastomer content per 100 parts of PVC (by weight) can be 3 parts or greater, 7 parts or greater, 10 parts or greater, 15 parts or greater, or 20 parts or greater. In some embodiments, in view of compatibility with PVC, etc., the elastomer content (by weight) of the substrate layer is suitably 75 parts or less, preferably 60 parts or less, possibly 50 parts or less, 40 parts or less, 30 parts or less, 25 parts or less, 20 parts or less, or 15 parts or less.

While no particular limitations are imposed, the substrate layer has an elastomer to plasticizer content ratio (by weight) of, for instance, 0.05 or higher and 2.0 or lower, or preferably 0.1 or higher and 1.5 or lower. The combined use of the elastomer and the plasticizer at such a content ratio can favorably bring about a PSA tape that has a good balance of easy deformability at low temperatures, good flexibility at room temperature, and deformation resistance at high temperatures.

### (Aliphatic Acid Metal Salt)

The substrate layer in the art disclosed herein preferably comprises an aliphatic acid metal salt in addition to the PVC and the plasticizer. In the substrate layer, during processing of the PVC film or the PVC adhesive tape or in a use environment of the PSA tape, PVC in the PVC film is sometimes exposed to physical energy such as heat, UV rays or shearing force, and chemical reactions or the like due to the exposure may cause discoloration or impair physical, mechanical or electrical properties. The aliphatic acid metal salt in the substrate layer may serve as a stabilizer to prevent or inhibit the chemical reactions.

As the aliphatic acid metal salt, solely one species or a combination of two or more species can be used among compounds capable of serving as PVC film stabilizers. For instance, the aliphatic acid forming the aliphatic acid metal salt can be preferably selected among saturated and unsaturated aliphatic acids (possibly hydroxy aliphatic acids) with about 10 to 20 (typically 12 to 18) carbons, such as lauric acid, ricinoleic acid and stearic acid. In view of ease of molding and processing of the PVC film, etc., a stearic acid metal salt can be preferably used. In view of flexibility at low temperatures and inhibition of changes with time in the PVC film or PVC adhesive tape, a lauric acid metal salt can be preferably used. In some preferable embodiments, a stearic acid metal salt and a lauric acid metal salt can be used in combination. In such a case, the ratio of the amount of lauric acid metal salt to the amount of stearic acid metal salt can be, for instance, 0.1 to 10 by weight, or it is usually suitably 0.2 to 5 (e.g., 0.5 to 2).

As the metal forming the aliphatic acid metal salt, in view of the recent increasing concern to environmental health, a metal other than lead (lead-free metal) is preferably used. Even in an embodiment using no such lead-containing stabilizer, the art disclosed herein can provide a PVC adhesive tape that shows good properties. As the metal, a metal can be selected among species belonging to Groups 1, 2, 12, 13 and 14 (but excluding Pb) of the periodic table, with favorable examples including Li, Na, Ca, Mg, Zn, Ba and Sn. As the aliphatic acid metal salt, from the standpoint of the cost, availability, etc., a Ca salt or a Ba salt can be preferably used. From the standpoint of the case of molding and processing the PVC film, a Zn salt can be preferably used. In some preferable embodiments, a Ca salt and a Zn salt can be used in combination. In this embodiment, the ratio of the amount of the Zn salt used to the amount of the Ca salt used is not particularly limited. For instance, by weight, the ratio value can be 0.1 to 10, or it is usually suitably 0.2 to 5 (e.g., 0.5 to 2). The art disclosed herein can be preferably implemented, for instance, in an embodiment including calcium stearate and zinc laurate at an aforementioned weight ratio or in an embodiment including zinc stearate and calcium laurate at an aforementioned weight ratio. It is noted that for an application that allows the use of an aliphatic acid Pb salt, the PVC film can comprise an aliphatic acid Pb salt.

The amount of aliphatic acid metal salt is not particularly limited. The amount of aliphatic acid metal salt (when using two or more species, their total amount) in the substrate layer can be, for instance, 0.01 wt % or more. In view of obtaining greater effects, it is preferably 0.05 wt % or more, and more preferably 0.1 wt % or more. The maximum amount of aliphatic acid metal salt is not particularly limited. It is typically suitably 10 wt % or less of the substrate layer. In view of flexibility at low temperatures, it is preferably 5 wt % or less, possibly 3 wt % or less, or even 1 wt % or less. Aliphatic acid metal salts may not be used.

### (Antioxidant)

The substrate layer in the art disclosed herein, the PVC film may comprise an antioxidant in addition to the PVC and plasticizer. With the antioxidant in the substrate layer, the resulting PVC adhesive tape may have superior durability.

As the antioxidant, known materials capable of preventing oxidation can be used without particular limitations. Examples of the antioxidant include phenol-based antioxidants, phosphorous-based antioxidants, sulfur-based antioxidants and amine-based antioxidants. For the antioxidant, solely one species or a combination of two or more species can be used.

Favorable examples of the antioxidant include phenol-based antioxidants such as hindered phenol-based antioxidants. Examples of hindered phenol-based antioxidants include pentaerythritol tetrakis [3-(3,5-di-tert-butyl-4-hydroxyphenyl) propionate] (trade name IRGANOX 1010 available from Ciba Japan K.K.), octadecyl-3-(3,5-di-tert-butyl-4-hydroxyphenyl) propionate (trade name IRGANOX 1076 available from Ciba Japan K.K.), 4,6-bis(dodecylthiomethyl)-o-cresol (trade name IRGANOX 1726 available from Ciba Japan K.K.), triethylene glycol bis [3-(3-tert-butyl-5-methyl-4-hydroxyphenyl) propionate] (trade name IRGANOX 245 available from Ciba Japan K.K.), bis(2,2,6,6-tetramethyl-4-piperidyl) sebacate (trade name TINUVIN 770 available from Ciba Japan K.K.) and a polycondensate of dimethyl succinate and 4-hydroxy-2,2,6,6-tetramethyl-1-piperidineethanol (dimethyl succinate-1-(2-hydroxyethyl)-4-hydroxy-2,2,6,6-tetramethylpiperidine polycondensate) (trade name TINUVIN 622 available from Ciba Japan K.K.). In particular, pentaerythritol tetrakis [3-(3,5-di-tert-butyl-4-hydroxyphenyl) propionate] (trade name IRGANOX 1010 available from Ciba Japan K.K.), triethylene glycol bis [3-(3-tert-butyl-5-methyl-4-hydroxyphenyl) propionate] (trade name IRGANOX 245 available from Ciba Japan K.K.) and the like are preferable.

The amount of antioxidant (when two or more species are used, their combined amount) is not particularly limited. For instance, it can be 0.001 wt % or more of the substrate layer. In view of obtaining greater effects, in typical, the amount of antioxidant in the substrate layer is suitably 0.01 wt % or greater, preferably 0.05 wt % or greater, or more preferably 0.1 wt % or greater. The maximum amount of antioxidant is not particularly limited. In typical, it is suitably 10 wt % or less.

### (Filler)

The substrate layer disclosed herein can comprise one, two or more species among various fillers as necessary. The substrate layer preferably includes a filler in view of increasing the thermal deformation resistance and abrasion resistance of the substrate layer (and further of the PSA tape). As the filler, organic fillers, inorganic fillers and organic-inorganic composite fillers can all be used. The filler may have been subjected to a known or commonly-used surface treatment. In view of cost and availability, an inorganic filler is preferably used.

Examples of the filler include aluminum hydroxide, magnesium hydroxide, zirconium hydroxide, calcium hydroxide, potassium hydroxide, barium hydroxide, triphenyl phosphate, ammonium polyphosphate, amide polyphosphate, zirconium oxide, magnesium oxide, zinc oxide, titanium oxide, molybdenum oxide, guanidine phosphate, hydrotalcite, smectite, zeolite, zinc borate, zinc borate anhydride, zine metaborate, barium metaborate, antimony oxide, antimony trioxide, antimony pentoxide, red phosphorus, tale, alumina, silica, boehmite, bentonite, silicate soda, calcium silicate, calcium sulfate, calcium carbonate, magnesium carbonate and carbon black. In particular, more preferable are hydrotalcite, talc, alumina, silica, calcium silicate, calcium sulfate, calcium carbonate and magnesium carbonate, and more preferable is calcium carbonate.

As the surface-treated filler, various fillers as specifically exemplified can be surface-treated and used. For example, an inorganic compound surface-treated with a silane coupling agent can be preferably used. As the inorganic compound, one, two or more species can be used among materials known or commonly used as inorganic flame retardants. For instance, among the specific examples of the filler, the inorganic compounds (e.g., magnesium hydroxide, aluminum hydroxide, basic magnesium carbonate, calcium carbonate, hydrotalcite) can be used.

The silane coupling agent used for the surface treatment is a silane compound having a structure obtained by chemically bonding an organic functional group compatible or reactive with organic resins and a hydrolysable silyl group compatible or reactive with an inorganic material. The silicon-bonded hydrolysable group is an alkoxy group, acetoxy group, etc. Typical examples of the alkoxy group include methoxy and ethoxy groups. Examples of the organic functional group include amino, methacryl, vinyl, epoxy, and mercapto groups. Specific examples of the silane coupling agent include vinyl triethoxysilane, vinyl-tolyl (2-methoxy-ethoxy) silane, γ-methacryloxypropyl trimethoxysilane, γ-aminopropyl trimethoxysilane, γ-aminopropyl triethoxysilane, N-phenyl-γ-aminopropyl trimethoxysilane, N-β-(aminoethyl)-γ-aminopropyl trimethoxysilane, N-β-(aminoethyl)-γ-aminopropyl triethoxysilane, N-phenyl-γ-aminopropyl triethoxysilane, β-(3,4-epoxycyclohexyl)ethyltrimethoxysilane, γ-glysidoxy propyltrimethoxysilane and γ-mercapto propyltrimethoxysilane. These can be used alone as one species or in combination of two or more species.

The method for surface treatment method of the inorganic compound with silane coupling agent is not particularly limited, and can be a common method such as dry treatment and wet treatment. The amount of silane coupling agent on the inorganic compound surface can vary depending on the species of coupling agent as well as the species of inorganic compound and its specific surface area. Thus, it is not limited to a particular range. It is typically in the range of 0.1 wt % to 5.0 wt %, or preferably 0.3 wt % to 3.0 wt % relative to the inorganic compound.

The particle diameter of the filler or that of the inorganic compound to be surface-treated is not particularly limited. It is typically about 0.1 μm or greater and 50 μm or less, or preferably about 0.5 μm to 20 μm. The particle diameter is measured by laser diffraction.

In an embodiment where the substrate layer comprises the filler, the filler content of the substrate layer is appropriately set in a range where the effect of the art disclosed herein is not impaired, and is not limited to a specific range. The filler content of the substrate layer may be, for instance, 1 wt % or more, 3 wt % or more, or 5 wt % or more. The maximum filler content is typically suitably 15 wt % or less, possibly, for instance, 12 wt % or less, 10 wt % or less, or 8 wt % or less (e.g., 6.5 wt % or less). The art disclosed herein can be implemented even in an embodiment essentially free of a filler.

The art disclosed herein is preferably implemented in an embodiment where the substrate layer comprises at least one species among hydrotalcite, tale, alumina, silica, calcium silicate, calcium sulfate, calcium carbonate and magnesium carbonate (or the “favorable inorganic filler group”; more favorably calcium carbonate) as the filler. In such an embodiment, the amount of other filler (i.e., filler other than the favorable inorganic filler group) of the substrate layer may be, for instance, less than 100 wt % relative to 100 wt % of the favorable inorganic filler group. The other filler content may be approximately 50 wt % or less, 10 wt % or less, or 1 wt % or less relative to 100 wt % of the favorable inorganic filler group. The art disclosed herein can be implemented in an embodiment having a substrate layer free of a filler other than the favorable inorganic filler group.

### (Optional Additives)

The substrate layer in the art disclosed herein can further comprise, as necessary, a known additive that can be used in a PVC film (especially in a PVC film for PVC adhesive tapes) as far as the effect of the present invention is not significantly impaired. Examples of such additives include colorants such as pigments and dyes, stabilizers other than aliphatic acid metal salts (e.g., organic tin compounds such as dioctyltin laurate), auxiliary stabilizers (e.g., phosphites such as trialkyl phosphite and tetra-alkyl(propane-2,2-diylbis(4,1-phenylene) bis(phosphite)), photostabilizers, UV-ray absorbers, modifiers, flame retardants, antistatic agents, antifungal agents and lubricants.

In the substrate layer according to some preferable embodiments, the amount of other components besides the polyvinyl chloride, the plasticizer and the elastomer is less than 15 wt %. This tends to preferably bring about the effect of selecting the amount of plasticizer relative to PVC. The amount of other components besides the polyvinyl chloride and the plasticizer in the substrate layer may be less than 12 wt %, less than 10 wt %, or less than 8 wt %. The minimum amount of other components besides the polyvinyl chloride and the plasticizer in the substrate layer is not particularly limited. In view of favorably obtaining the effect of the additive inclusion, it is suitably 1 wt % or more, and may be 3 wt % or more, or 5 wt % or more (e.g., 7 wt % or more).

A PVC film having such a composition can be obtained typically by molding a PVC composition having the corresponding composition into a film form by a method known in the field of thermoplastic resin film. As such known molding methods, for instance, melt extrusion (inflation, T-die extrusion, etc.), melt casting, and calendar molding can be employed. The art disclosed herein can be preferably implemented also in an embodiment using for the PVC film a film that has not been subjected to a treatment to purposefully increase crosslinking of the overall PVC film. The treatment can be addition of a crosslinking agent (e.g., polyfunctional monomer such as trimethylolpropane trimethacrylate), irradiation of active energy rays (e.g., electron beam), etc. Such a PVC film tends to readily bring about a highly flexible PVC adhesive tape capable of maintaining the functions and properties (e.g., edge peeling and deflectability).

As an example, a typical procedure for making a film by calendar molding is outlined below.
(1) Measuring: PVC, plasticizer and other materials used as necessary are weighed out in accordance with the target composition.
(2) Mixing: The respective weighed materials are mixed while stirring to prepare a uniform mixture (typically a mixture in a powder form, i.e., a powder mixture).
(3) Kneading: The mixture prepared in (2) above is melted with heat and kneaded with two, three or more kneading rollers (typically metal rollers). The temperature of the kneading rollers is suitably set to, for instance, 100° C. to 250° C. (preferably 150° C. to 200° C.).
(4) Calendar molding: The kneaded mixture obtained in (3) above is placed in a calender molding machine to mold a PVC film having an arbitrary thickness.

In the PSA tape disclosed herein, the substrate layer is typically a monolayer or multilayer support substrate formed of a PVC film. The PSA tape may also comprise another layer in addition to the PVC film substrate layer. In some embodiments, the other layer may be an auxiliary layer, such as a print layer, release-treated layer, or primer layer formed on the PVC film surface. Preferable embodiments include a configuration where a PSA layer is placed on one side of the substrate layer formed of a monolayer PVC film. Such a PSA tape may have a PSA layer directly placed on the PVC film substrate layer, free of an auxiliary layer (e.g., the aforementioned print layer, release-treated layer, primer layer, etc.) between the substrate layer and the PSA layer.

In the PSA tape disclosed herein, the substrate layer has a thickness of typically 500 μm or less, suitably 450 μm or less, possibly 400 μm or less (e.g., less than 400 μm), less than 350 μm, less than 300 μm, less than 250 μm, or less than 220 μm. The substrate layer with not too large a thickness is preferable in view of case of wrapping the PSA tape around wires, etc., and is also advantageous in preventing edge peeling after wrapping. By limiting the substrate layer thickness, weight reduction can also be achieved. In some embodiments, the substrate layer thickness can be less than 200 μm, for instance, less than 190 μm. The substrate layer thickness is, for instance, 30 μm or greater. In view of the strength and handling properties of the PSA tape, it is preferably 55 μm or greater, or more preferably 70 μm or greater. In some embodiments, the substrate layer thickness is, for instance, greater than 105 μm, greater than 115 μm, 130 μm or greater, 140 μm or greater, 150 μm or greater, 160 μm or greater, 200 μm or greater, 250 μm or greater, or 300 μm or greater. The substrate layer thickness can be preferably applied to a PSA tape used for protecting or binding electric wires of a wire harness. With increasing substrate layer thickness, the substrate tends to be more susceptible to cracking due to bending deformation of the wire harness at a low temperature and also tends to have an increased bending rigidity value at room temperature. According to the art disclosed herein, however, even in an embodiment with a relatively large substrate thickness, the resulting PSA tape can have a good balance of easy deformability at low temperatures, good flexibility at room temperature, and deformation resistance at high temperatures. When using the wire harness with the exposed outer surface without an exterior-protective material (i.e., the backside of the PSA tape is exposed, not covered with a protective material), for instance, if the wire harness is routed in a path that may interfere with the vehicle body or other parts, the backside of the PSA tape may be repeatedly rubbed due to the interference. In such usage conditions, it can also be advantageous to increase the substrate layer thickness in view of increasing the durability (abrasion resistance) of the PSA tape.

Of the support substrate, the surface to which the PSA layer is placed may be subjected as necessary to heretofore known surface treatments such as corona discharge treatment, plasma treatment, UV-ray irradiation, acid treatment, alkali treatment, primer coating and antistatic treatment. These treatments may be provided to increase the tightness of adhesion between the substrate and PSA layer (i.e., anchoring of the PSA layer to the substrate). The primer composition is not particularly limited and can be suitably selected from known compositions. The primer layer thickness is not particularly limited. It is usually preferably 0.01 μm or greater and 2 μm or less, or more preferably 0.1 μm or greater and 1 μm or less.

In the PVC adhesive tape in an embodiment where the PSA layer is placed solely on one face of the substrate layer, the face (backside) to which no PSA layer is placed may be subjected as necessary to heretofore known surface treatments such as release treatment and antistatic treatment. For instance, the backside of the substrate may be provided with a long-chain alkyl-based, silicone-based or like release layer to reduce the unwinding force of the wound roll of PVC adhesive tape. For purposes such as increasing the printability, reducing the light reflection and increasing the ease of application in layers, the backside may be subjected to treatments such as corona discharge treatment, plasma treatment, UV-ray irradiation, acid treatment and alkali treatment.

### <PSA Layer>

The PSA layer in the art disclosed herein is a layer formed from a material that exists as a soft solid (a viscoelastic material) in a room temperature range and has a property to adhere easily to adherend with some pressure applied. As defined in “Adhesion: Fundamental and Practice” by C. A. Dahlquist (McLaren & Sons (1966), P. 143), the PSA referred to herein is normally a material that has a property satisfying complex tensile modulus E*(1 Hz)<10⁷ dyne/cm² (typically, a material that exhibits the described characteristics at 25° C.).

The PSA layer in the art disclosed herein may be formed from a PSA composition in various forms, such as a water-dispersed PSA composition, aqueous PSA composition, solvent-based PSA composition, hot-melt PSA composition and active energy ray-curing PSA composition. Here, the term “active energy ray” refers to an energy ray having energy capable of causing a chemical reaction such as polymerization, crosslinking and initiator decomposition, with the concept thereof encompassing lights such as UV rays, visible lights and infrared lights as well as radioactive rays such as a rays, β rays, γ rays, electron beam, neutron radiation and X rays. A PSA layer formed from a water-dispersed PSA composition is preferable because it is likely to reduce diffusion of the plasticizer in the PVC film into the PSA layer and inhibit temporal changes of adhesive strength, etc.

### (Base Polymer)

The species of PSA constituting the PSA layer is not particularly limited. The PSA may comprise as its base polymer (the primary component among polymers) one, two or more species among various rubbery polymers known in the PSA field, such as rubber-based polymers, acrylic polymers, polyester-based polymers, urethane-based polymers, polyether-based polymers, silicone-based polymers, polyamide-based polymers and fluorine-based polymers. Here, the rubber-based PSA refers to a PSA that comprises a rubber-based polymer as the base polymer. The same applies to the acrylic PSA and other PSA. The acrylic polymer refers to a polymer that comprises a monomeric unit derived from an acrylic monomer (a monomer having at least one (meth)acryloyl group per molecule) and typically refers to a polymer that comprises a monomer unit derived from an acrylic monomer at a ratio above 50 wt %. The (meth)acryloyl group comprehensively refers to the acryloyl group and methacryloyl group.

In some embodiments, the PSA layer is formed from a water-dispersed PSA composition comprising rubber latex or an acrylic polymer emulsion, and a tackifier resin emulsion. Such a rubber-based or acrylic PSA can be used to obtain a PVC adhesive tape with good adhesive properties. Such a PVC adhesive tape may prevent edge peeling for long periods. In some preferable embodiments, the rubber latex comprises natural rubber latex and styrene-butadiene rubber latex.

### (Rubber-Based Polymer)

As the PSA layer of the PVC adhesive tape disclosed herein, a PSA layer comprising a rubber-based PSA as the primary component (i.e., a rubber-based PSA layer) can be preferably used. The rubber-based PSA may comprise one, two or more species of rubber-based polymer selected from natural and synthetic rubbers. In this description, the “primary component” refers to a component that accounts for more than 50 wt % unless otherwise indicated. As the rubber-based polymer, either natural rubber or synthetic rubber can be used. As the natural rubber, known materials usable in PSA compositions can be used without particular limitations. The concept of natural rubber referred to here is not limited to unmodified natural rubbers, encompassing modified natural rubbers that have been modified with, for instance, an acrylic acid ester, etc. Unmodified and modified natural rubbers may be used together. As the synthetic rubber, known materials that can be used in PSA compositions can be used without particular limitations. Favorable examples include styrene-butadiene rubber (SBR), styrene-isoprene rubber and chloroprene rubber. These synthetic rubbers can be unmodified or modified (e.g., carboxy-modified). For the rubber-based polymer, solely one species or a combination of two or more species can be used.

The PVC adhesive tape according to some preferable embodiments may have a rubber-based PSA layer formed from a water-dispersed rubber-based PSA composition obtained by adding a tackifier resin and other additives as necessary to rubber-based latex. The rubber-based latex can be a water dispersion of various known rubber-based polymers. Either natural rubber latex or synthetic rubber latex can be used. As the natural rubber latex, known materials that can be used in PSA compositions can be used without particular limitations. The concept of natural rubber latex referred to here is not limited to unmodified natural rubber latexes, encompassing modified natural rubber latexes that have been modified with, for instance, an acrylic acid ester, etc. Unmodified and modified natural rubber latexes may be used together. As the synthetic rubber latex, known materials that can be used in PSA compositions can be used without particular limitations. Favorable examples include styrene-butadiene rubber latex (SBR latex), styrene-isoprene rubber latex and chloroprene rubber latex. These synthetic rubber latexes can be unmodified or modified (e.g., carboxy-modified). For the rubber-based latex, solely one species or a combination of two or more species can be used.

The rubber-based PSA composition (e.g., water-dispersed, rubber-based PSA composition) according to some preferable embodiments comprises both a natural rubber and a synthetic rubber as the rubber-based polymer. With such a PSA composition, the PVC adhesive tape can be formed to show good adhesive properties. For instance, the PVC adhesive tape can be formed to show adhesive properties suited for applications such as protection and binding of electric wires, pipes and the like, covering of corrugated tubes as described above, and electric insulation. The natural rubber to synthetic rubber weight ratio (natural rubber:synthetic rubber) is preferably in a range of about 10:90 to 90:10, more preferably in a range of about 20:80 to 80:20, or yet more preferably in a range of about 30:70 to 70:30. As the synthetic rubber, SBR can be preferably used.

### (Acrylic Polymer)

In another preferable embodiment, the PSA layer can be an acrylic PSA layer primarily comprising an acrylic PSA. The acrylic PSA helps obtain a PSA tape having excellent heat resistance. The acrylic polymer in the acrylic PSA can be a (meth)acrylic polymer whose primary monomer is a (meth)acrylate (acrylic ester, methacrylic ester). The acrylic polymer used in the acrylic PSA is preferably formed as an emulsified acrylic polymer (acrylic polymer emulsion).

As the acrylic polymer, it is particular preferable to use an alkyl (meth)acrylate-based polymer whose primary monomer is an alkyl (meth)acrylate. The alkyl (meth)acrylate-based polymer may be a homopolymer of solely one species of alkyl (meth)acrylate or a copolymer of an alkyl (meth)acrylate with another (meth)acrylate (e.g., cycloalkyl (meth)acrylate or aryl(meth)acrylate) or a comonomer (monomer copolymerizable with alkyl (meth)acrylates). That is, in the alkyl (meth)acrylate-based polymer, monomers such as alkyl (meth)acrylates can be used singly or in combination of two or more species.

Examples of alkyl (meth)acrylates in the acrylic polymer include C₁₋₂₀ alkyl (meth)acrylate esters such as methyl (meth)acrylate, ethyl (meth)acrylate, propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (methacrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. In particular, C₂₋₁₄ alkyl (meth)acrylates are preferable, and C₂₋₁₀ alkyl (meth)acrylates are more preferable. As the alkyl (meth)acrylate, butyl (meth)acrylate and 2-ethylhexyl (meth)acrylate are particularly favorable. “C_{X-Y}” such as “C₁₋₂₀” means that the number of carbon atoms is X or greater and Y or less. C_{X-Y} alkyl (meth)acrylate refers to an alkyl (meth)acrylate having an ester-end alkyl group with from X up to Y number of carbons.

The (meth)acrylate is used as a primary monomer. The amount of (meth)acrylate (particularly, alkyl (meth)acrylate) is typically 50 wt % or more relative to the total amount of monomers. In view of adhesion and cohesion, it is preferably 80 wt % or more, or more preferably 90 wt % or more.

In the acrylic polymer, examples of the monomer copolymerizable with alkyl (meth)acrylates include carboxy group-containing monomers such as (meth)acrylic acid (acrylic acid, methacrylic acid), itaconic acid, maleic acid, fumaric acid and crotonic acid; acid anhydride group-containing monomers such as maleic anhydride and itaconic anhydride; cyanoacrylate-based monomers such as acrylonitrile and methacrylonitrile; aminoalkyl (meth)acrylate-based monomers such as aminoethyl (meth)acrylate, N,N-dimethylaminoethyl (meth)acrylate and t-butylaminoethyl (meth)acrylate; (N-substituted) amide-based monomers such as (meth)acrylamide, N,N-dimethyl (meth)acrylamide, N-butyl (meth)acrylamide, N-hydroxy (meth)acrylamide, N-methylol (meth)acrylamide and N,N-dimethylaminopropyl (meth)acrylamide; vinyl ester-based monomers such as vinyl acetate and vinyl propionate; styrene-based monomers such as styrene, α-methylstyrene and vinyl toluene; hydroxyl group-containing monomers such as 2-hydroxyethyl (meth)acrylate, 3-hydroxypropyl (meth)acrylate and 4-hydroxybutyl (meth)acrylate; epoxy group-containing acrylic monomers such as glycidyl (meth)acrylate; alkoxy alkyl (meth)acrylate-based monomers such as methoxyethyl (meth)acrylate and ethoxyethyl (meth)acrylate; lactone acrylate-based monomers such as ε-caprolactone acrylate; olefin-based monomers such as ethylene, propylene, isoprene and butadiene; vinyl ether-based monomers such as methylvinyl ether and ethylvinyl ether; and heterocycle-containing vinyl-based monomers such as morpholino (meth)acrylate; N-vinyl-2-pyrroridone, N-vinylpyridine, N-vinylpiperidone, N-vinylpyrimidine, N-vinylpiperazine, N-vinylpyrazine, N-vinylpyrrole, N-vinylimidazole, and N-vinyloxazole. These comonomers can be used singly as one species or in combination of two or more species. Favorable examples of the comonomer include carboxy group-containing monomers (e.g., acrylic acid and/or methacrylic acid).

In the acrylic polymer, as the comonomer, a polyfunctional monomer can also be used, such as hexanediol di(meth)acrylate, (poly)ethylene glycol di(meth)acrylate, (poly) propylene glycol di(meth)acrylate, neopentyl glycol di(meth)acrylate, pentaerythritol di(meth)acrylate, trimethylolpropane tri(meth)acrylate, pentaerythritol tri(meth)acrylate, dipentaerythritol hexa (meth)acrylate, epoxy acrylate, polyester acrylate, urethane acrylate, divinylbenzene, butyl di(meth)acrylate or hexyl di(meth)acrylate.

The polymerization method for the acrylic polymer is not particularly limited. Various heretofore known polymerization methods can be suitably employed. Examples of suitable polymerization methods include thermal polymerization such as solution polymerization, emulsion polymerization, and bulk polymerization (typically performed in the presence of a thermal polymerization initiator); photopolymerization with irradiation of light such as UV rays (typically performed in the presence of a photopolymerization initiator); and radiation polymerization with irradiation of radioactive rays such as β rays or γ rays. Two or more polymerization methods can be combined and performed (e.g., step by step).

When the acrylic PSA is formed of an emulsified acrylic polymer, it is preferable to use an acrylic polymer prepared by emulsion polymerization while it is still possible to use an emulsion (emulsified with an emulsifier as necessary) of an acrylic polymer prepared by a polymerization method (solution polymerization, etc.) other than emulsion polymerization.

As the polymerization method for acrylic polymer, any method can be employed among general batch polymerization, polymerization with continuous dropping, and polymerization with dropping in portions, etc. A plurality of polymerization methods may be combined. The polymerization reaction may be carried out incrementally. For instance, after polymerization is carried out for a while, some monomers can be added for further polymerization.

When the acrylic polymer is prepared by emulsion polymerization, among known emulsifiers, one species or a combination of two or more species can be used in polymerization. In particular, as the emulsifier, it is preferable to use a reactive emulsifier having a (meth)acrylate-copolymerizable group (e.g., a group having an ethylenic unsaturated bond). The reactive emulsifier form bonds with molecular chains (especially, molecular chains of acrylic polymer) in the PSA composition. This inhibits or prevents surface precipitation and migration of the emulsifier in the PSA layer, thereby effectively reducing or preventing decreases in adhesive strength and emulsifier contamination of adherends. Accordingly, the emulsified acrylic polymer used in the art disclosed herein is preferably prepared by emulsion polymerization of a monomer in the presence of a reactive emulsifier.

The reactive emulsifier only needs to have a (meth)acrylate-copolymerizable group while having an emulsifying ability. Examples include reactive emulsifiers with a radically-polymerizable functional group (radical reactive group) (e.g., propenyl group, allyl ether group) introduced in an emulsifier such as an anionic emulsifier (e.g., sodium lauryl sulfate, ammonium lauryl sulfate, sodium dodecylbenzene sulfonate, sodium polyoxyethylene alkyl ether sulfonate, ammonium polyoxyethylene alkyl phenyl ether sulfonate, sodium polyoxyethylene alkyl phenyl ether sulfonate, sodium polyoxyethylene alkyl sulfosuccinate), a nonionic emulsifier (e.g., polyoxyethylene alkyl ether, polyoxyethylene alkyl phenyl ether, polyoxyethylene aliphatic acid ester, a polyoxyethylene polyoxypropylene block polymer), or a nonionic-anionic emulsifier (e.g., sodium polyoxyethylene alkyl ether sulfonate, ammonium polyoxyethylene alkyl phenyl ether sulfonate, sodium polyoxyethylene alkyl phenyl ether sulfonate, sodium polyoxyethylene alkyl sulfosuccinate). The reactive emulsifiers can be used singly as one species or in combination of two or more species.

In addition, besides the reactive emulsifier, other emulsifiers (non-reactive emulsifiers) are not particularly limited. Suitable species can be selected from known emulsifiers. Specific examples of non-reactive emulsifiers include anionic emulsifiers such as sodium lauryl sulfate, ammonium lauryl sulfate, sodium dodecylbenzene sulfonate, sodium polyoxyethylene alkyl ether sulfonate, ammonium polyoxyethylene alkyl phenylether sulfonate, sodium polyoxyethylene alkyl phenylether sulfonate, and sodium polyoxyethylene alkyl sulfosuccinate; nonionic emulsifiers such as polyoxyethylene alkyl ether, polyoxyethylene alkyl phenyl ether, polyoxyethylene aliphatic acid ester, and polyoxyethylene polyoxypropylene block polymer; and nonionic-anionic emulsifiers such as sodium polyoxyethylene alkyl ether sulfonate, ammonium polyoxyethylene alkyl phenyl ether sulfonate, sodium polyoxyethylene alkyl phenyl ether sulfonate, and sodium polyoxyethylene alkyl sulfosuccinate. These non-reactive emulsifiers can be used singly as one species or in combination of two or more species.

The amount of emulsifier (especially, a reactive emulsifier) is appropriately selected depending on the emulsion and thus is not limited to a specific range. It is typically suitably 0.1 part to 20 parts (preferably 1 part to 10 parts) per 100 parts of monomer mixture by weight.

In polymerization for obtaining the acrylic polymer (favorably, acrylic polymer emulsion), a polymerization initiator, a chain transfer agent, or the like can be used. These are not limited particularly, and can be appropriately selected and used among known agents. Examples of the polymerization initiator include azo-based polymerization initiators such as 2,2′-azobisisobutylonitrile, 2,2′-azobis (2-methylpropionamidine) disulfide, 2,2′-azobis (4-methoxy-2,4-dimethylvaleronitrile), 2,2′-azobis (2,4-dimethylvaleronitrile), 2,2′-azobis (2-methylbutylonitrile), 1,1′-azobis (cyclohexane-1-carbonitrile), 2,2′-azobis (2,4,4-trimethylpentane), dimethyl-2,2′-azobis (2-methylpropionate), 2,2′-azobis [2-methyl-N-(phenylmethyl)-propionamidine] dihydrochloride, 2,2′-azobis [2-(3,4,5,6-tetrahydropirimidine-2-yl) propane] dihydrochloride, and 2,2′-azobis [2-(2-imidazoline-2-yl) propane]; persulfate salt-based polymerization initiators such as potassium persulfate and ammonium persulfate; peroxide-based polymerization initiators such as benzoyl peroxide, hydrogen peroxide, t-butyl hydroperoxide, di-t-butyl peroxide, t-butylperoxy benzoate, dicumyl peroxide, 1,1-bis (t-butylperoxy)-3,3,5-trimethylcyclohexane, 1,1-bis (t-butylperoxy) cyclododecane, 3,3,5-trimethylcyclohexanoyl peroxide, and t-butylperoxy pivalate; and redox-based polymerization initiators formed from a persulfate salt and sodium hydrogen sulfite. The polymerization initiators can be used alone as one species or in combination of two or more species. The amount of the polymerization initiator is not particularly limited, and is appropriately selected depending on the polymerization method or polymerization reactivity, monomer species and amounts thereof, species of polymerization initiator, etc. For example, it can be appropriately selected within the range of 0.005 part to 1 part per 100 parts of monomer mixture by weight.

As the chain transfer agent, for instance, one, two or more species can be selected and used among lauryl mercaptan, glycidyl mercaptan, mercaptoacetic acid, 2-mercaptoethanol, thioglycolic acid, 2-ethylhexyl thioglycolate, and 2,3-dimethylcapto-1-propanol.

### (Tackifier Resin)

The PSA layer (e.g., rubber-based or acrylic PSA layer) in the art disclosed herein may comprise a tackifier resin in addition to the base polymer as described above. As the tackifier resin, a suitable species can be selected and used among various known tackifier resins. For example, one, two or more species can be used, selected from various tackifier resins including rosin-based resins, petroleum-based resins, terpene-based resins, phenolic resins, coumarone-indene-based resins and ketone-based resins. In an embodiment of forming the PSA layer from a water-dispersed PSA composition (favorably, a water-dispersed rubber-based PSA composition), a tackifier resin emulsion is preferably used as the tackifier resin.

Examples of rosin-based resins include rosin derivatives such as disproportionated rosins, hydrogenated rosins, polymerized rosins, maleinated rosins and fumarated rosins as well as phenol-modified rosins and rosin esters. Examples of phenol-modified rosins include products of addition reactions of natural rosins or rosin derivatives and phenols, and phenol-modified rosins obtainable by reactions of resolic phenol resins and natural rosins or rosin derivatives. Examples of rosin esters include esterified products of the rosin-based resins reacted with polyols. Rosin-phenol resins can be esterified as well.

Examples of terpene-based resins include terpene resins (a-pinene resins, β-pinene resins, limonene resins, etc.), terpene phenol resins, aromatic modified terpene resins and hydrogenated terpene resins.

Examples of petroleum-based resins include aliphatic (C5) petroleum resins, aromatic (C9) petroleum resins, aliphatic/aromatic copolymer-based (C5/C9) petroleum resins, hydrogenated products of these (e.g., alicyclic petroleum resins obtainable by hydrogenating aromatic petroleum resins) and various modified products thereof (e.g., maleic acid anhydride modified product).

Examples of phenolic resins include condensation products of formaldehyde and various phenols such as phenol, m-cresol, 3,5-xylenol, p-alkylphenol and resorcinol. Other examples of phenolic resins include resoles obtainable by base-catalyzed addition reactions of the phenols and formaldehyde, and novolacs obtainable by acid-catalyzed condensation reactions of the phenols and formaldehyde.

Examples of coumarone-indene-based resins include coumarone-indene resin, hydrogenated coumarone-indene resin, phenol-modified coumarone-indene resin and epoxy-modified coumarone-indene resin.

Examples of ketone resins include ketone resins formed by condensation of formaldehyde and ketones (e.g., aliphatic ketones such as methyl ethyl ketone and methyl isobutyl ketone and alicyclic ketones such as cyclohexanone and methyl cyclohexanone).

In some preferable embodiments (e.g., an embodiment using a rubber-based PSA), as the tackifier resin, a petroleum-based resin (preferably, aliphatic (C5) petroleum resin) and a phenol-based resin (preferably, alkyl phenol resin) are used together. In such an embodiment, their usage ratio is not particularly limited. For example, the petroleum-based resin content A to phenol-based resin content B ratio (B/A) by weight can be 1 or greater, preferably 2 or greater, or more preferably 2.5 or greater; and suitably 15 or less, or preferably 9 or less. In other embodiments (e.g., an embodiment using an acrylic PSA), a rosin-based resin is preferably used as the tackifier resin.

The softening point of the tackifier resin used is not particularly limited. In some embodiments (e.g., embodiments using a rubber-based PSA), for instance, a tackifier resin having a softening point of 60° C. to 160° C. can be used. A tackifier resin that is in a liquid state at room temperature can be used as well. From the standpoint of combining cohesion and low-temperature properties (e.g., unwinding force and adhesive strength at low temperatures) at a good balance, a tackifier resin having a softening point of 60° C. to 140° C. (more preferably 80° C. to 120° C.) can be preferably used. For instance, a petroleum-based resin having a softening point in this range is preferably used. In other embodiments (e.g., an embodiment using an acrylic PSA), it is preferable to use a tackifier resin having a softening point of approximately 200° C. or lower (more preferably, approximately 180° C. or lower). The minimum softening point of such a tackifier resin is not particularly limited. For instance, it can be approximately 135° C. or higher (further, approximately 140° C. or higher). The softening point of a tackifier resin can be measured based on the softening point test method (ring and ball method) specified in JIS K2207.

The ratio of the polymers to the tackifier resin in the PSA layer is not particularly limited and can be suitably selected in accordance with the application. In some embodiments, based on non-volatiles, the tackifier resin content per 100 parts by weight of polymers can be, for instance, 20 parts by weight or greater, or it is usually suitably 50 parts by weight or greater. From the standpoint of obtaining greater effects of its use, the amount of the tackifier resin used per 100 parts by weight of polymers can be 80 parts by weight or greater, or even 100 parts by weight or greater. On the other hand, from the standpoint of the low-temperature properties, etc., the amount of the tackifier resin used per 100 parts by weight of polymers is suitably 200 parts by weight or less, or preferably 150 parts by weight or less. In other embodiments, the amount of tackifier resin can be appropriately set within the range of, for instance, 1 part to 100 parts per 100 parts of base polymer (favorably, an acrylic polymer) by weight. In view of cohesive strength, the amount (by weight) of tackifier resin per 100 parts of base polymer (favorably, an acrylic polymer) is suitably 50 parts or less, possibly 20 parts or less, or 10 parts or less.

### (Crosslinking Agent)

In the art disclosed herein, the PSA composition for forming the PSA layer may comprise a crosslinking agent as necessary. The species of crosslinking agent is not particularly limited, and can be suitably selected and used among hitherto known crosslinking agents. Examples of such crosslinking agents include isocyanate-based crosslinking agents, epoxy-based crosslinking agents, oxazoline-based crosslinking agents, aziridine-based crosslinking agents, melamine-based crosslinking agents, peroxide-based crosslinking agents, urea-based crosslinking agents, metal alkoxide-based crosslinking agents, metal chelate-based crosslinking agents, metal salt-based crosslinking agents, carbodiimide-based crosslinking agents, hydrazine-based crosslinking agents, amine-based crosslinking agents, and silane coupling agents. Among them, isocyanate-based crosslinking agents, epoxy-based crosslinking agents, oxazoline-based crosslinking agents, aziridine-based crosslinking agents, and melamine-based crosslinking agents are preferable; isocyanate-based crosslinking agents and epoxy-based crosslinking agents are more preferable; and epoxy-based crosslinking agents are particularly preferable. The crosslinking agents can be used singly as one species or in combination of two or more species.

The amount of crosslinking agent is not particularly limited. For example, it can be approximately 10 parts or less per 100 parts of base polymer (favorably, an acrylic polymer) by weight, and can be selected within the range of preferably about 0.005 part to 10 parts by weight, or more preferably about 0.01 part to 5 parts by weight.

### (Other Additives)

In embodiments using a water-dispersed PSA composition as the PSA composition, it is preferable to use a protective colloid such as a water-soluble salt of casein with the water-dispersed PSA composition in view of insulation properties, moisture resistance, etc.

As for other components, the PSA layer may comprise as necessary various additives generally used in the PSA field, such as viscosity modifier (thickener, etc.), leveling agent, plasticizer, softener, colorant such as pigment and dye, photostabilizer, anti-aging agent, antioxidant, waterproofing agent, antistatic agent, foaming agent, anti-foaming agent, surfactant, and preservative.

The PSA layer can be formed by suitably employing various heretofore known methods. For instance, it is possible to employ a direct method where a PSA composition is directly provided (typically applied) to a substrate (typically a PVC film) as described above and allowed to dry to form a PSA layer. A transfer method can also be used where a PSA composition is provided to a releasable surface (release face) and allowed to dry to form a PSA layer on the surface, and the PSA layer is transferred to a substrate. These methods can be combined as well. As the release face, a release liner surface, a release-treated backside of a support substrate, and the like can be used.

The PSA composition can be applied with a known or commonly-used coater such as a gravure coater, reverse roll coater, kiss roll coater, dip roll coater, bar coater, knife coater and spray coater. The PSA layer is typically formed continuously. Depending on the purpose and application, it may be formed in a regular or random pattern of dots, stripes, etc.

While no particular limitations are imposed, the PSA layer has a thickness of typically 2 μm or more, typically suitably 5 μm or more, preferably 10 μm or more, or more preferably 15 μm or more. With increasing PSA layer thickness, good adhesive properties tend to be readily obtained, for instance, helping to better prevent edge peeling. The maximum PSA layer thickness is typically suitably 50 μm or less, preferably 40 μm or less, more preferably 30 μm or less, and yet more preferably 25 μm or less. By limiting the PSA layer thickness, weight reduction can also be achieved. For instance, these PSA layer thickness ranges can be preferably applied to PVC adhesive tapes used for protecting and binding electric wires and pipes, covering corrugated tubes as described above, electric insulation and so on. In particular, it can be preferably applied to a PSA tape used for protecting or binding electric wires of a wire harness.

The substrate layer thickness T_{S} (μm) to PSA layer thickness T_{PSA} (μm) ratio (T_{S}/T_{PSA}) is not particularly limited, and can be set within a suitable range for obtaining the effect of the art disclosed herein. In some embodiments, the ratio (T_{S}/T_{PSA}) is preferably in the range of 6 to 13. When the ratio (T_{S}/T_{PSA}) is 6 or higher, high abrasion resistance tends to be readily obtained. When the ratio (T_{S}/T_{PSA}) is 13 or lower, good adhesive properties (adhesive strength, etc.) and flexibility are likely obtained. The ratio (T_{S}/T_{PSA}) is more preferably 8 or higher, and may be 9 or higher, 10 or higher, or 11 or higher. The ratio (T_{S}/T_{PSA}) is more preferably 12 or lower, and may be 10.5 or lower, or 9.5 or lower.

The total PSA tape thickness is the total of the substrate layer thickness and the PSA layer thickness described above (excluding the release liner thickness) and can be, for instance, in the range of about 40 μm to 600 μm. In view of ease of wrapping the PSA tape around wires, etc., in some embodiments, the total PSA tape thickness can be, for instance, 500 μm or less, 450 μm or less, 400 μm or less, 350 μm or less, 300 μm or less, 250 μm or less, or 200 μm or less. The total PSA tape thickness can be, for instance, 50 μm or greater, 75 μm or greater, 90 μm or greater, 120 μm or greater, 150 μm or greater, or 180 μm or greater. The total PSA tape thickness can be preferably applied to a PSA tape used for protecting or binding electric wires in a wire harness.

### <Applications>

The PSA tape disclosed herein can simultaneously exhibit well-balanced favorable properties (e.g., easy deformability at low temperatures, good flexibility at room temperature, and deformation resistance at high temperatures). Thus, for instance, it is favorable for applications such as protecting and binding of electric wires, pipes, etc.; covering of corrugated tubes that wrap and protect electric wires and the like; electric insulation; and so on. Particularly preferable applications include binding and fastening wire harnesses (e.g., possibly wire harnesses for automobiles, other vehicles and aircraft, especially wire harnesses for vehicles and aircraft comprising internal combustion engines) as well as covering, binding and fastening of corrugated tubes for wire harnesses. The wire harnesses can be used, placed near the internal combustion engines (e.g., inside engine rooms). The PSA tape disclosed herein is not limited to these applications and can be favorably used in various fields where PVC adhesive tapes are used, such as interlayer and outer surface insulation, attachment, labeling and identification of electric parts (transformers, coils, etc.), electronic components, etc.

When using the PSA tape disclosed herein in a wire harness, the wire harness can be used in an embodiment where the backside of the PSA tape is covered with a protective material (e.g., an embodiment with an exterior-protective material) or in a form without the protective material covering the backside. In the wire harness according to some preferable embodiments, the backside of the PSA tape is not covered with a protective material and is exposed. The PSA tape disclosed herein has good anti-crack properties at low temperatures and good deformation resistance at high temperatures. Thus, there is no need for the protective material that has been conventionally placed around the wire harness to avoid a decrease in protection with PSA tape due to cracking or deformation. Wire harnesses without protective materials are highly productive and can be made lighter in weight.

Several working examples related to the present invention are described below, but the present invention is not intended to be limited to these examples. In the description below, “parts” and “%” are by weight unless otherwise specified.

### Example 1

### (Preparation of PVC Film)

The respective starting materials shown in Table 1 were weighed out and mixed together to form the composition shown in the same table (i.e., the composition including 40 parts plasticizer, 5 parts Elastomer A, 10 parts filler, 2 parts stabilizer, 0.3 part auxiliary stabilizer, and 1.7 parts pigment). After kneading, with a calender molding machine, at a molding temperature of 150° C., the mixture was molded into a 180 μm thick long sheet (film) to obtain a PVC film (substrate) according to this example. The following starting materials were used: as PVC, product name S-70 (available from Formosa Plastics Corporation, 1350 polymerization degree); as plasticizer, diisononyl phthalate (product name DINP available from J-PLUS Co., Ltd.); as Elastomer A, a thermoplastic polyurethane copolymer (thermoplastic polyurethane elastomer (TPU) (water-resistant polyester-based), product name ELASTOLLAN C90A10 available from BASF Japan Ltd., A90 durometer hardness, 16 mol % urethane bonds); as filler, calcium carbonate (product name CS1600 available from Riu Shang Industrial Co., Ltd); as stabilizer, product name OW-5000LTS (available from Sakai Chemical Industry Co., Ltd., composite stabilizer for PVC); as auxiliary stabilizer, product name ADK STAB 1500 (available from ADEKA Corporation); and as pigment, product name BC-3082 (black pigment available from DIC Taiwan Ltd.).

### (Preparation of PSA Composition)

At 30° C., were mixed 100 parts of natural rubber latex (product name HYTEX, available from Nomura Trading Co., Ltd.) and 1 part of an emulsifier (product name NOPCO 38-C available from San Nopco Limited) under nitrogen flow for 2 hours. Subsequently, was added a mixture of 10 parts of methyl methacrylate and 1 part of cumene hydroperoxide. The resultant was mixed while stirring for 1 hour. To this, was further added 0.4 part of tetraethylene pentaamine. The resultant was mixed while stirring for 4 hours to obtain an acrylated natural rubber latex. Based on solid content, were mixed 20 parts of the acrylated natural rubber latex, 20 parts of a natural rubber latex (product name HYTEX available from Nomura Trading Co., Ltd.) and 60 parts of a styrene-butadiene copolymer latex (product name 2108 available from JSR Corporation) to prepare a rubber-based latex.

In 40 parts of heptane, were dissolved 80 parts of an aliphatic petroleum resin (product name RB100 available from JXTG Energy Corporation) and 20 parts of an alkyl phenol resin (product name TACKIROL 201 available from Taoka Chemical Co., Ltd.) as tackifier resins to prepare a resin solution. Were heated and dissolved 4 parts of casein, 15 parts of 28% ammonia water per 100 parts of casein, and 60 parts of water to prepare an aqueous ammonium casein solution. This was used as a protective colloid. The resulting aqueous ammonium casein solution was allowed to cool to 40° C., mixed with 8 parts of an ammonium salt of a hydrogenated rosin (60% dihydroabietic acid) as an emulsifier. This was then added to the resin solution. The resulting mixture was stirred at 40° C. at a rotation speed of 800 rpm for 1 hour using a T.K. HOMODISPER (available from Tokushu Kika Kogyo Co., Ltd.) to prepare a tackifier resin emulsion.

Based on solid content, were mixed 100 parts of the resulting rubber-based latex and 100 parts of a tackifier resin emulsion to obtain an aqueous PSA composition.

### (Preparation of PSA Tape)

Using a comma direct coater, to a surface of the PVC film, the PSA composition was applied, dried and wound over a length sufficient for conducting the undermentioned evaluation test to obtain a PSA tape according to this example. The coating amount of the PSA composition was adjusted so that the PSA layer formed had a thickness of 20 μm after dried. The original length was slit to a width of 19 mm to obtain a PSA tape according to this example, with the tape having a PSA layer on one surface of the PVC film.

### Examples 2-14 and Comparative Examples 1-4

Using the PVC film compositions as shown in Tables 1 to 3, but otherwise in the same manner as Example 1, were prepared PSA tapes according to the respective examples. The following materials were used: as Elastomer B, a thermoplastic polyurethane copolymer (thermoplastic polyurethane elastomer (TPU) (polyester-based), product name ELASTOLLAN S80A10 available from BASF Japan Ltd., A80 durometer hardness, 13 mol % urethane bonds); as Elastomer C, a thermoplastic polyurethane copolymer (TPU (polyether-based), product name ELASTOLLAN 1180A10 CLEAR, available from BASF Japan Ltd., A80 durometer hardness, 12 mol % urethane bonds); as Elastomer D, a thermoplastic polyester copolymer (thermoplastic polyester elastomer (TPEE), product name HYTREL 4001 available from Du Pont-Toray Co., Ltd., D40 durometer hardness); as Elastomer E, a (meth)acrylate-butadiene-styrene copolymer (methyl methacrylate-butadiene-styrene copolymer (MBS), product name KANE ACE B-22 available from Kaneka Corporation); and as Elastomer F, an ethylene-vinyl acetate copolymer (EVA, product name GREEN EFFECT 630P available from Sanyo Trading Co., Ltd.).

### <Evaluations>

### (Low-Temperature Bend Test)

Were obtained two 30 cm long fluororesin-insulated flexible single-core wires (JUNFLON ETFE wire, 1.12 mm finished outer diameter, 0.15 mm thick insulation (0.82 mm inner diameter) purchased from MISUMI Corporation). While applying a load to one end of a PSA tape (19 mm wide) of interest, the tape was wrapped around the two wires in a half-wrap manner (with each wrap overlapping the previous wrap by half the width of the PSA tape) to prepare a test sample. The load was 50 g per 25 μm tape thickness. The test sample was left standing in an environment at −40° C. for 30 minutes. In the same temperature environment, manually holding both ends of the test sample, as shown in FIG. 2, about the middle of the length of test sample 50 was placed orthogonally against a 4 mm diameter iron rod 52 (with the two wires aligned in the length direction of iron rod 52) and bent by hand until the both ends made contact with each other. Bending of sample 50 was carried out at a roughly constant speed over about 3 seconds from the start of bending to the contact of both ends.

After the sample was brought back to room temperature, the bent part was visually observed and evaluated according to the marking scheme shown below. The passing mark is 2 points (pts) or higher.
3 pts: No cracking was observed in the PSA tape.
2 pts: Some cracking was observed in the PSA tape, but with no wire exposure.
1 pt: Significant cracking was observed in the PSA tape, exposing wires.

### (Measurement of Bending Rigidity at Room Temperature)

Bending rigidity at room temperature (or RT bending rigidity) was determined in an environment at 25° C., using a pure bending tester, model KES-FB2-S, available from Kato Tech Co., Ltd.

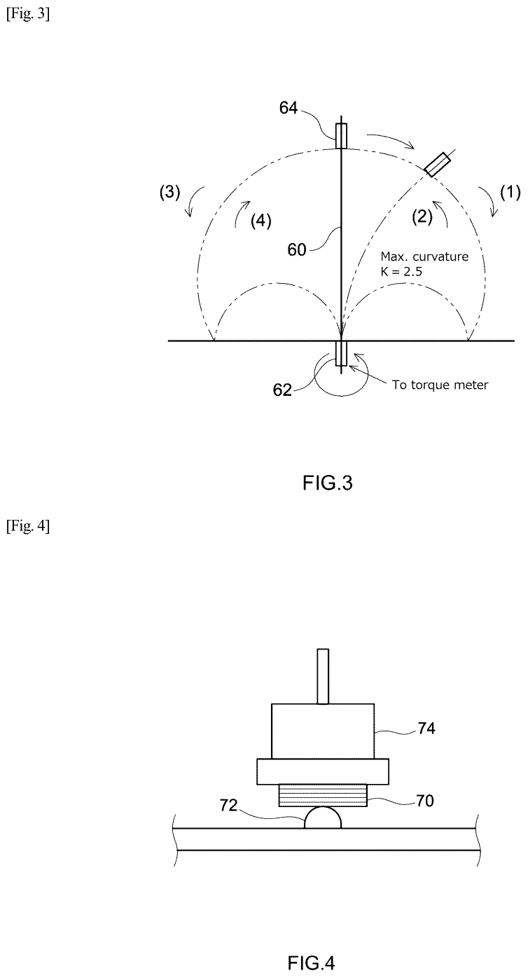

In particular, a 100 mm square sample was cut from the original (non-slit) PSA tape of interest, and sprinkled with baby powder to eliminate the tackiness of the adhesive surface. The sample was set in the pure bending tester. As shown in FIG. 3 (schematic top view of the device), with sample 60, at a maximum bending curvature of 2.5 cm⁻¹ and a curvature change rate of 0.5 cm⁻¹/sec, moving chuck 64 was moved relative to fixed chuck 62 in the following order and cycle (measurement made over one cycle): (1) front bending outward path (increasing curvature), (2) front bending return path (decreasing curvature), (3) back bending outward path (increasing curvature), and (4) back bending return path (decreasing curvature). The sample is bent with the substrate layer on the inner side in the front bending outward path, and with the PSA layer on the inner side in the back bending outward path. With respect to each of the front and back bending outward paths, the bending rigidity was calculated by dividing the sample's bending moment per cm-width (gf·cm/cm) by the curvature (cm⁻¹), and their average value was taken as the sample's bending rigidity (gf·cm²/cm).

### (Measurement of Thermal Deformation)

Thermal deformation was determined in an environment at 80° C., using TP-201 Heat Transformational Tester available from Testers Sangyo Co., Ltd.

In particular, from the PSA tape (19 mm wide) of interest, 50 mm lengths were cut and laminated to a thickness of about 2.0 mm to prepare a sample for thermal deformation measurement. The thickness (initial thickness T₀) of the sample was measured and then left standing in an environment at 80° C. for 30 minutes. Subsequently, in the same temperature environment, as shown in FIG. 4, the sample (70) was placed on a metal rod 72 with a semicircular cross section (5 mm radius), with its PSA-layer-exposed side facing metal rod 72 and the center of its width touching metal rod 72. A 2.0 kg load (74) was applied onto sample 70 (on the substrate-layer-exposed side). After 5 minutes of standing, the thickness (post-deformation thickness T₁) of sample 70 was measured. The percent change in post-deformation thickness T₁ relative to the initial thickness T₀ was determined as the percent (%) thermal deformation.

In this experiment, in the respective examples described above, the PVC film thickness and the PSA layer thickness were changed to 360 μm and 40 μm, respectively; and five sheets of PSA tape (0.4 mm thick) were laminated to prepare samples. These samples were used to carry out the thermal deformation measurement.

The PSA tape according to each example was tested for low-temperature bending and evaluated for bending rigidity at room temperature and thermal deformation. The results are shown in Tables 1 to 3 along with the substrate composition of the PSA tape according to each example.

TABLE 1

| | | | Example | | | | | |
|---|---|---|---|---|---|---|---|---|
| | | | 1 | 2 | 3 | 4 | 5 | 6 |
| Substrate | PVC | | 100 | 100 | 100 | 100 | 100 | 100 |
| composition | Plasticizer | | 40 | 40 | 40 | 40 | 40 | 40 |
| (parts by wt) | Elastomer | (hardness) | | | | | | |
| | A: TPU (polyester-based) | (A90) | 5 | 7.8 | 9.6 | 15 | 30 | 50 |

| | Filler | 10 | 10 | 10 | 10 | 10 | 10 |
|---|---|---|---|---|---|---|---|
| | Stabilizer | 2 | 2 | 2 | 2 | 2 | 2 |
| | Auxiliary stabilizer | 0.3 | 0.3 | 0.3 | 0.3 | 0.3 | 0.3 |
| | Pigment | 1.7 | 1.7 | 1.7 | 1.7 | 1.7 | 1.7 |
| % elastomer of substrate (by weight) | | 3.1% | 4.8% | 5.9% | 8.9% | 16.3% | 24.5% |
| Test results | Low-temerature bending test (pts) | 2 | 3 | 3 | 3 | 3 | 3 |
| | RT bending rigidity(gf · cm²/cm) | 0.60 | 0.56 | 0.51 | 0.42 | 0.39 | 0.18 |
| | Thermal deformation(%) | 7.0 | 6.7 | 6.2 | 5.8 | 5.6 | 5.5 |

TABLE 2

| | | | Example | | | | | |
|---|---|---|---|---|---|---|---|---|
| | | | 7 | 8 | 9 | 10 | 11 | 12 |
| Substrate | PVC | | 100 | 100 | 100 | 100 | 100 | 100 |
| composition | Plasticizer | | 40 | 40 | 40 | 40 | 40 | 40 |
| (parts by wt) | Elastomer | (hardness) | | | | | | |
| | B: TPU (polyester-based) | (A80) | 10 | 30 | — | — | — | — |
| | C: TPU (polyether-based) | (A80) | — | — | 10 | 30 | — | — |
| | D: TPEE (D40) | (D40) | — | — | — | — | 10 | 30 |

| | Filler | 10 | 10 | 10 | 10 | 10 | 10 |
|---|---|---|---|---|---|---|---|
| | Stabilizer | 2 | 2 | 2 | 2 | 2 | 2 |
| | Auxiliary stabilizer | 0.3 | 0.3 | 0.3 | 0.3 | 0.3 | 0.3 |
| | Pigment | 1.7 | 1.7 | 1.7 | 1.7 | 1.7 | 1.7 |
| % elastomer of substrate (by weight) | | 6.1% | 16.3% | 6.1% | 16.3% | 6.1% | 16.3% |
| Test results | Low-temerature bending test (pts) | 3 | 3 | 2 | 3 | 3 | 3 |
| | RT bending rigidity(gf · cm²/cm) | 0.48 | 0.41 | 0.50 | 0.36 | 0.59 | 0.45 |
| | Thermal deformation(%) | 6.1 | 5.7 | 5.8 | 5.4 | 6.4 | 5.9 |

TABLE 3

| | | Example | | Comparative Example | | | |
|---|---|---|---|---|---|---|---|
| | | 13 | 14 | 1 | 2 | 3 | 4 |
| Substrate | PVC | 100 | 100 | 100 | 100 | 100 | 100 |
| composition | Plasticizer | 36 | 44 | 40 | 50 | 40 | 40 |
| (parts by wt) | Elastomer | | | | | | |
| | A: TPU (polyester-based) | 14.5 | 14.5 | — | — | — | — |
| | E: MBS | — | — | — | — | 30 | — |
| | F: EVA | — | — | — | — | — | 30 |
| | Filler | 10 | 10 | 10 | 10 | 10 | 10 |
| | Stabilizer | 2 | 2 | 2 | 2 | 2 | 2 |
| | Auxiliary stabilizer | 0.3 | 0.3 | 0.3 | 0.3 | 0.3 | 0.3 |
| | Pigment | 1.7 | 1.7 | 1.7 | 1.7 | 1.7 | 1.7 |
| % elastomer of substrate (by weight) | | 8.8% | 8.4% | 0.0% | 0.0% | 16.3% | 16.3% |
| Test results | Low-temerature bending test (pts) | 3 | 3 | 1 | 1 | 3 | 3 |
| | RT bending rigidity(gf · cm²/cm) | 0.65 | 0.38 | 0.86 | 0.11 | 0.98 | 0.27 |
| | Thermal deformation(%) | 5.6 | 6.0 | 7.6 | 8.0 | 5.8 | 10.9 |

As shown in the tables, with respect to the PSA tapes of Examples 1 to 14 having a PSA layer on a PVC film with the PVC film comprising PVC and a plasticizer and further comprising TPU or TPEE as an elastomer, they passed the low-temperature (−40° C.) bending test with 2 pts or higher, had a suitably-low bending rigidity at room temperature (23° C.) and showed a minimal thermal deformation at 80° C., exhibiting well-balanced properties over a wide temperature range from low to high temperatures.

On the other hand, the elastomer-free PSA tape of Comparative Example 1 was susceptible to cracking at the low temperature and had somewhat high bending rigidity at room temperature. As for Comparative Example 2 in which the amount of plasticizer was increased to increase flexibility, while the RT bending rigidity decreased, the low-temperature bending test was not passed, and the thermal deformation increased than Comparative Example 1. Between Comparative Examples 3 and 4 using only an elastomer that is not either TPU or TPEE, in Comparative Example 3, the RT bending rigidity further increased than Comparative Example 1; and in Comparative Example 4, the thermal deformation increased significantly.

TPU and TPEE are both thermoplastic elastomers classified as multiblock copolymers, not belonging to the class of elastomers such as methyl methacrylate-butadiene-styrene copolymer (MBS) and ethylene-vinyl acetate copolymer. Thus, the matters disclosed in this description include a PSA tape having a substrate layer formed of a PVC film and a PSA layer placed on at least one face of the substrate layer, in which the substrate layer comprises PVC, a plasticizer and an elastomer; and the elastomer comprises a multiblock copolymer-based thermoplastic elastomer. The multiblock copolymer-based thermoplastic elastomer can be used singly or in combination of two or more species. TPU and TPEE may be preferable examples under the concept of the multiblock copolymer-based thermoplastic elastomer.

Although specific embodiments of the present invention have been described in detail above, these are merely for illustrations and do not limit the scope of claims. The art according to the claims includes various modifications and changes made to the specific embodiments illustrated above.

### REFERENCE SIGNS LIST

1 PSA tape
11 substrate layer
11A first face
11B second face
21 PSA layer
21A surface (adhesive face)
50 sample
52 iron rod
60 sample
62 fixed chuck
64 moving chuck
70 sample
72 metal rod
74 load

1. A pressure-sensitive adhesive tape comprising a substrate layer formed of a polyvinyl chloride film, and a pressure-sensitive adhesive layer on at least one side of the substrate layer, wherein
the substrate layer comprises polyvinyl chloride, a plasticizer, and an elastomer, and
the elastomer comprises at least a thermoplastic polyurethane or a thermoplastic polyester elastomer.

2. The pressure-sensitive adhesive tape according to claim 1, wherein the substrate layer comprises the elastomer in an amount of 3.0% by weight or greater and 30% by weight or less.

3. The pressure-sensitive adhesive tape according to claim 1, wherein the elastomer comprises at least the thermoplastic polyurethane.

4. The pressure-sensitive adhesive tape according to claim 3, wherein the thermoplastic polyurethane has a urethane bond fraction of 10% by mole or higher and 20% by mole or lower.

5. The pressure-sensitive adhesive tape according to claim 1, wherein the elastomer satisfies at least a durometer hardness of A75 or greater and A95 or less, or a durometer hardness of D25 or greater and D45 or less.

6. The pressure-sensitive adhesive tape according to claim 1, wherein the substrate layer comprises the plasticizer in an amount of 15% by weight or greater and 30% by weight or less.

7. The pressure-sensitive adhesive tape according to claim 1, wherein a ratio of the elastomer amount to the plasticizer amount in the substrate layer is 0.1 or higher and 1.5 or lower on weight basis.

8. A wire harness comprising electric wires, and the pressure-sensitive adhesive tape according to claim 1, wherein the pressure-sensitive adhesive tape is wrapped around the electric wires.
